(19) United States
(12) Patent Application Publication
(10) Pub. No.: US 2002/0061001 A1
(43) Pub. Date: May 23, 2002

(54) Dynamic source tracing (DST) routing protocol for wireless networks

(75) Inventors: J. J. Garcia -Luna -Aceves, San Mateo, CA (US); Jyoti Raju, Saratoga, CA (US)

Correspondence Address: John P. O'Banion, O'BANION & RITCHEY LLP, Suite 1550, 400 Capitol Mall, Sacramento, CA, 95814, US

(73) Assignee: THE REGENTS OF THE UNIVERSITY OF CALIFORNIA

(21) Appl. No.: 09/939,529

(22) Filed: Aug. 24, 2001

Related U.S. Application Data
(60) Provisional application No. 60/228,060, filed on Aug. 25, 2000.

(51) Int. Cl. H04Q 7/24

(52) U.S. Cl. 370/338; 370/400

(57) ABSTRACT

An efficient routing method (i.e., protocol) for use with wireless ad-hoc networks, referred to as “dynamic source tracing” or DST routing, that considerably reduces control overhead and thereby increases the available bandwidth while conserving power at the mobile stations. DST routing also provides high user throughput and can operate efficiently in a variety of traffic situations. DST employs a source-tracing algorithm that provides loop checking of complete paths prior to an entry being made into the routing table. In addition, DST makes use of information about the length and second-to-last hop (predecessor) of the shortest path to all known destinations, thus eliminating the counting to infinity problem, such as exhibited by the distributed Bellman-Ford protocol.

### CROSS-REFERENCE TO RELATED APPLICATIONS

This application claims priority from U.S. provisional application serial No. 60/228,060 filed on Aug. 25, 2001, which is incorporated herein by reference. This application is also related to co-pending U.S. application Ser. No. 09/883,082 filed on Jun. 15, 2001.

### STATEMENT REGARDING FEDERALLY SPONSORED RESEARCH OR DEVELOPMENT

This invention was made with Government support under Grant No. F30602-97-2-0338, awarded by the Air Force Office of Scientific Research (AFOSR). The Government has certain rights in this invention.

### REFERENCE TO A COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

The present invention pertains generally to routing protocols for wireless ad-hoc networks, and more particularly to a method of on-demand distance vector routing within ad-hoc networks.

2. Description of the Background Art

Ad-hoc networks, also known as multi-hop packet-radio networks, typically consist of mobile hosts that are interconnected by routers that can also move. This architecture is used when there is no wired infrastructure in place. Examples of such networks are networks set up in disaster or military scenarios, and networks set up at temporary events such as a class lecture or business convention. In most instances, not all stations are within line of sight of each other or a base station. Therefore, packets have to be relayed several times over multiple-access channels. Due to limited transmission range, mobility causes frequent changes in connectivity; that is, the network topology is dynamic. All the stations are identical and serve as both sources and relays of data traffic.

Due to the multihop and dynamic nature of ad-hoc networks, a distributed routing protocol is required to forward packets between mobile stations and to and from the Internet. Routers in an ad-hoc network can easily run routing protocols designed for wired networks, provided the routers contain proper stacks. However, wireless networks suffer from low bandwidth and high rates of interference. This implies that routing protocols should generate as few updates as possible, so as to use the least possible bandwidth for control traffic. Mobility also increases the bandwidth used for control packets. As links go up and down frequently, more updates need to be sent to maintain correct topology information. As congestion due to control overhead increases, the convergence time of the routing algorithm increases.

Considerable work has been done in the development of routing protocols for ad-hoc networks, starting in the 1970's with work on the DARPA PRNET and SURAN projects. In recent years, the interest in ad-hoc networks has grown due to the availability of wireless communication devices that work in the ISM bands in the U.S.

Routing for ad-hoc networks can be classified into two main types: (i) table-driven and (ii) on-demand. Table driven routing attempts to maintain consistent information about the path from each node to every other node in the network. For example, the Destination-Sequenced Distance-Vector Routing (DSDV) protocol is a table driven algorithm that modifies the Bellman-Ford routing algorithm to include timestamps that prevent loop-formation. The Wireless Routing Protocol (WRP) is a distance vector routing protocol which belongs to the class of path-finding algorithms that exchange second-to-last hop to destinations in addition to distances to destinations. This extra information helps remove the “counting-to-infinity” problem that most distance vector routing algorithms suffer from. It also speeds up route convergence when a link failure occurs.

On-demand routing protocols were designed with the aim of reducing control overhead, thus increasing bandwidth and conserving power at the mobile stations. These protocols limit the amount of bandwidth consumed by maintaining routes to only those destinations for which a source has data traffic. Therefore, the routing is source-initiated as opposed to table-driven routing protocols that are destination initiated. There are several recent examples of this approach, such as AODV, ABR, DSR, TORA, SSA, and ZRP, and the routing protocols differ with regard to the specific mechanisms used to disseminate flood-search packets and their responses, cache the information heard from other nodes' searches, determine the cost of a link, and determine the existence of a neighbor. However, all of the on-demand routing proposals use flood search messages that either: (a) give sources the entire paths to destinations, which are then used in source-routed data packets (e.g., DSR); or (b) provide only the distances and next hops to destinations, validating them with sequence numbers (e.g., AODV) or time stamps (e.g., TORA).

Several studies have been published comparing the performance of the above routing protocols using different simulators, mobility models and performance metrics. One of the first comprehensive studies was done by the Monarch project of CMU reported in J. Broch et al., “A Performance Comparison of Multi-Hop Wireless Ad Hoc Network Routing Protocols”, Proc. ACM Mobicom 98, October 1998. This study compared DSDV, AODV, DSR and TORA and introduced some standard metrics that may be used in further studies of wireless routing protocols. A paper by S. R. Das et al., “Comparative Performance Evaluation of Routing Protocols for Mobile Ad-Hoc Networks”, 7^{th} Int. Conf. on Comp. Communication and Networks, pages 153-161, October 1998, compares a larger number of protocols. However, link level details and MAC interference are not modeled. This may not give an adequate reflection of the delays suffered by packets that are made to wait while the MAC protocol acquires the channel. It also does not reflect how high data traffic rate may interfere with routing protocol convergence. Another recent study by P. Johansson et al., “Scenario-based Performance Analysis of Routing Protocols for Mobile Ad-Hoc Networks”, Proc. IEEE/ACM Mobicom '99, pp. 195-206, August 1999, compares the same protocols as in J. Broch et al. This study used specific scenarios to test the protocol behavior. Based on their results, all of these papers conclude that on-demand routing protocols perform better than table-driven routing protocols. However, all of the table-driven routing protocols tested use the optimum routing approach. In other words, these protocols try to maintain shortest paths at all times. A consequence of maintaining shortest paths is that if the topology of the network changes rapidly, the control overhead increases dramatically.

Therefore, there is a need for an efficient and reliable routing protocol for ad-hoc networks. The present invention satisfies that need, as well as others, and overcomes deficiencies in current table-driven and on-demand protocols.

### BRIEF SUMMARY OF THE INVENTION

In general terms, the present invention comprises an efficient routing method (i.e., protocol) for use with wireless ad-hoc networks, which is also referred to herein as “dynamic source tracing” (DST) routing. DST routing is particularly well suited to ad-hoc networks because it considerably reduces control overhead and thereby increases the available bandwidth while conserving power at the mobile stations. DST routing also provides high user throughput and can operate efficiently in a variety of traffic situations.

The DST protocol of the present invention is a new approach to on-demand distance vector routing for ad-hoc networks. As in other on-demand algorithms, DST acquires routes to destinations only when traffic for those destinations exists and there is no correct route to the given destination. This implies that route information is only maintained for destinations with which a router needs to communicate, and that the routes being utilized are not necessarily optimum routes. The routes being utilized need only be valid routes providing a finite metric value. According to one aspect of the invention, the DST protocol employs a source-tracing algorithm that provides loop checking of complete paths prior to an entry being made into the routing table. In accordance with another aspect of the invention, DST makes use of information about the length and second-to-last hop (predecessor) of the shortest path to all known destinations, thus eliminating the counting to infinity problem, such as exhibited by the distributed Bellman-Ford protocol. The DST protocol utilizes local clock timers and therefore does not require the use of sequence numbers for preventing continuous forwarding of query messages. A node according to the DST protocol does not lose all routing information when a node temporarily goes down, as occurs with sequence numbering. Sequence numbers also are used in typical protocols to assure loop free routing. DST by contrast gathers second-to-last hop information and therefore does not require the sequence number to be loop-free. Therefore DST is able to protect the network from errors that occur when nodes fail and sequence information is lost.

Data packets sent to destination nodes according to typical wireless networks utilize a header that generally includes a full routing path to the destination. The inclusion of this extended amount of information lowers the bandwidth that is available to the data. By contrast the DST protocol utilizes a header that contains only source and destination information, with no routing path, therefore bandwidth utilization is improved.

By way of example, and not of limitation, a node running DST maintains shortest paths to all known destinations in its routing tables in response to the demands of incoming traffic. A node also maintains the routing tables of known neighbors along with the link costs to known neighbors to generate its own routing table. A routing message broadcasted by a node contains a vector of entries where each entry corresponds to a route in a routing table; each entry contains a destination identifier j, the distance to the destination Dⁱⱼ, and the second-to-last hop to that destination pⁱⱼ.

An object of the invention is to provide an efficient routing algorithm that maintains efficiency in the presence of node failures.

Another object of the invention is to provide a routine algorithm that utilizes a source-tracing method to provide on-demand routing within an ad-hoc network.

Another object of the invention is to eliminate the necessity of requiring sequence numbers or internodal synchronization to ensure correctness.

Another object of the invention is to utilize source-tracing to eliminate routing loops.

Another object of the invention is to eliminate the necessity of reliable updating so that a reduction in communication overhead may be attained.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a graph of a query timeline in reference to the source and forwarding nodes according to an aspect of the present invention, showing the condition wherein t3-t1≧query_send_timeout.

FIG. 2A is a graph of routing activity within a six-node network with unity link costs, showing node d broadcasting a query for a destination a.

FIG. 2B is a graph of routing activity within a six-node network with unity link costs, showing nodes e, f, and c broadcasting queries.

FIG. 2C is a graph of routing activity within a six-node network with unity link costs, showing nodes a and b discovering a finite and valid route to a.

FIG. 2D is a graph of routing activity within a six-node network with unity link costs, showing a reply update being rebroadcast by e with the original pkt.dst and pkt.src.

FIG. 3 is a code listing showing procedures Init, Recv_CU_Packet( ), and Add_Dest( ) for use within the DST protocol according to an embodiment of the present invention.

FIG. 4 is a code listing showing procedures Rmv_Dest( ), Add_Nbr( ), and Rmv_Nbr( ) for use within the DST protocol according to an embodiment of the present invention.

FIG. 5 is a code listing showing procedure DT Update( ) for use within the DST protocol according to an embodiment of the present invention.

FIG. 6 is a code listing showing procedure Query( ) for use within the DST protocol according to an embodiment of the present invention.

FIG. 7 is a code listing showing procedure Update( ) for use within the DST protocol according to an embodiment of the present invention.

FIG. 8 is a code listing showing procedure RT_Update( ) for use within the DST protocol according to an embodiment of the present invention.

FIG. 9 is a code listing showing procedures Send_Update( ), Send_Query( ), Buffer_Timer_Callback( ) for use within the DST protocol according to an embodiment of the present invention.

FIG. 10 is a code listing showing procedures Get_Route_For_Pkt( ) for use within the DST protocol according to an embodiment of the present invention.

FIG. 11 is a code listing showing procedure Handle_Data_Packet( ) for use within the DST protocol according to an embodiment of the present invention.

FIG. 12 is a code listing showing procedure Check_Buffer( ) for use within the DST protocol according to an embodiment of the present invention.

FIG. 13A is a graph of routing activity within a six-node network with unity link costs, shown after the route discovery cycle started by node d.

FIG. 13B is a graph of routing activity within a six-node network with unity link costs, showing link failure between node a and node e.

FIG. 13C is a graph of routing activity within a six-node network with unity link costs, showing node d picking node c as its successor and changing its distance to “3” and predecessor to b.

FIG. 13D is a graph of routing activity within a six-node network with unity link costs, showing a failure occurring in the link between node c and b.

FIG. 13E is a graph of routing activity within a six-node network with unity link costs, showing the update from node b getting through to node d.

FIG. 14 is a graph of control packet overhead associated with varying the pause times for the DST, DSR, and BEST protocols, showing the number of control packets in response to varying the pause time interval.

FIG. 15 is a graph of the percentage of data packets which are delivered for the DST, DSR, and BEST protocols, showing the percentage of data packets received in response to variation of the pause time interval.

FIG. 16 is a graph of hop count values for the DST, DSR, and BEST protocols, showing the number of hops taken for each protocol as a percentage of data packets.

FIG. 17 is a graph of cumulative delays for the DST, DSR, and BEST protocols, showing the amount of delay encountered for each protocol as a percentage of control packet.

FIG. 18 is a graph which models traffic flows to and from an Internet attachment point within a wireless network.

FIG. 19 is a graph of the number of control packets utilized within the DST, DSR, and BEST protocols, showing results from a series of five simulation runs.

FIG. 20 is a graph of the percentage of data packets received within the DST, DSR, and BEST protocols, showing results from a series of five simulation runs.

FIG. 21 is a graph of the number of control packets sent within the DST, DSR, and BEST protocols, showing results from a series of five simulation runs.

FIG. 22 is a graph of the percentage of data packets received within the DST, DSR, and BEST protocols, showing results from a series of five simulation runs.

### DETAILED DESCRIPTION OF THE INVENTION

The present invention comprises a routing protocol for ad-hoc wireless networks, which we also refer to herein as dynamic source tracing (DST). The following description of the invention is for illustrative purposes, and those skilled in the art will appreciate from this description that the details presented herein may be modified without departing from the present invention.

1. Network Model

In describing the DST protocol, a network is modeled as an undirected graph with V nodes and E links. A node principally comprises a router which may be physically connected to multiple IP hosts, or IP-addressable devices. A router utilizes a single node identifier, instead of interface identifiers, which facilitates identifying the router with the network and to other application protocols. In a wireless network, a node is configured with radio connectivity with multiple nodes using a single physical radio link. Accordingly, physical broadcast links are mapped to connect a node with its multiple neighbors with point-to-point links. A positive, non-zero, cost is associated with the maintenance of each physical link, and the cost of a failed links is considered to be set to infinity. A node failure is modeled as all links incident on the given node getting set to infinity. For the purpose of routing-table updates, a node A considers another node B as a neighbor if A receives an update from neighbor B. Node B is no longer considered the neighbor of node A when the medium access protocol at node A sends a signal to DST indicating that data packets can no longer be sent successfully to node B.

The DST routing protocol is designed for operation over any wireless medium-access protocol. Routing messages are broadcast unreliably and the protocol assumes that routing packets may be lost due to changes in link connectivity, fading or jamming. Since the DST protocol only requires a MAC indication that data packets can no longer be sent to a neighbor, the need for a link-layer protocol for monitoring link connectivity with neighbors or transmitting reliable updates is eliminated, thus reducing control overhead. If such a layer can be provided with no extra MAC overhead, then the DST protocol can operate more proactively by identifying lost neighbors before data for them arrives. The availability of node connectivity information results in faster convergence time and it decreases data packet losses.

2. Routing Information Maintained in DST

A router operating with DST protocols maintains a routing table, a distance table, a data buffer, and a query table. The routing table at router i contains entries for all known destinations with each entry comprising a destination identifier j, the successor to that destination sⁱⱼ, the second-to-last hop to the destination pⁱⱼ, the distance to the destination Dⁱⱼ and a route tag tagⁱⱼ. When the element tagⁱⱼ is set to a value of Correct, it implies a loop-free finite value route, when set to Null it implies that the route still remains to be checked, and when it is set to Error an infinite metric route, or a route with a loop, is implied. The distance table at router i preferably comprises a matrix of distance values of the route from i to j through k, Dⁱⱼₖ and the second-to-last hop pⁱⱼₖ on that route. It will be appreciated that Dⁱⱼₖ is set to where RD^{k}ⱼ is the distance reported by k to j in the last routing message and lⁱₖ is the cost of link (i,k). The link cost may be set to one reflecting hop count or it may be set to some other link parameter like latency, bandwidth, and so forth.

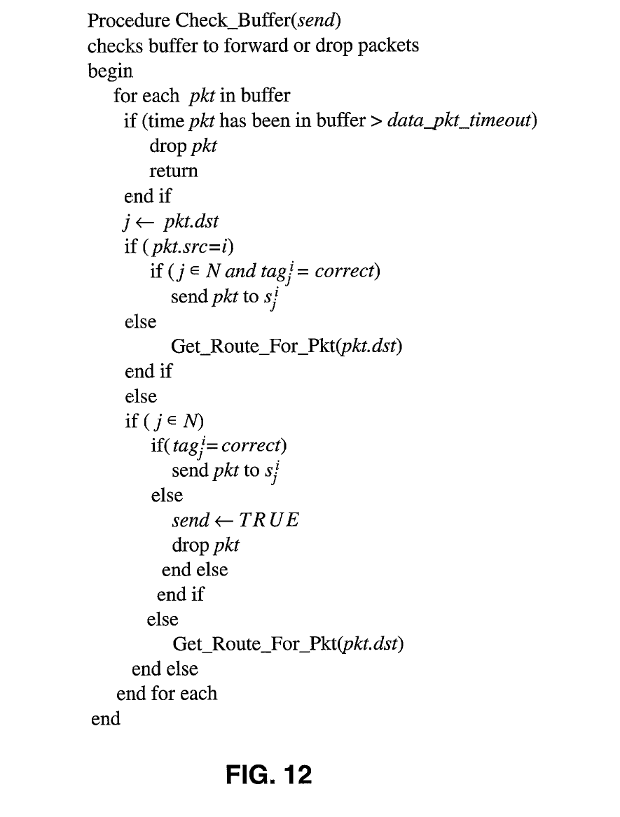

The data buffer is a queue which is capable of holding all the data packets waiting for routes to destinations. A conventional buffer management scheme was utilized within the present embodiment, although it should be appreciated that various alternative mechanisms could be selected for managing a buffer. The data buffer is configured with a limited size and upon filling up, the packet at the head of the queue is dropped to free up space for the incoming data packet. A time value is also associated with each of the data packets whose value is set to the time at which the packet was loaded into the buffer, and a packet that has been retained in the buffer for more than data_pkt_timeout seconds is dropped. The data buffer is checked periodically for any packets that may be sent or dropped as shown in the procedure Check_Buffer illustrated in FIG. 12.

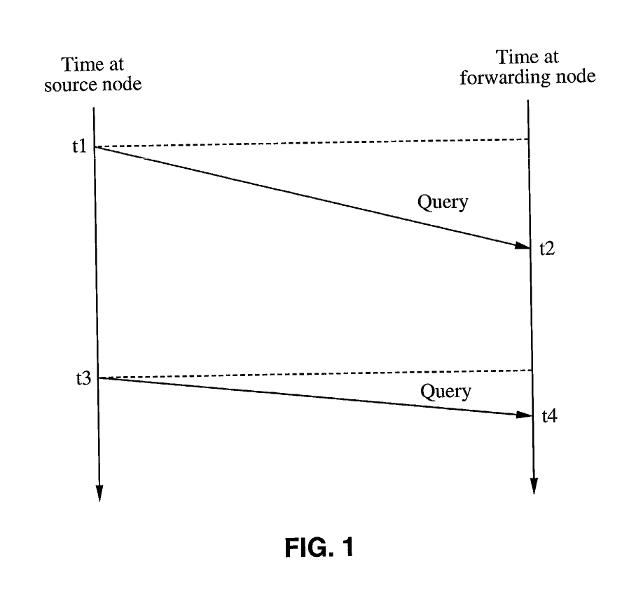

The query table prevents queries from being forwarded indefinitely. A forwarding scheme similar to the DSR protocol is utilized to allow for two forms of queries; queries with zero hop count which only get propagated to neighbors, and queries with maximum hop count that are forwarded to a maximum distance of MAX_HOPS hops from the sender. For each destination j, the query table contains the last time a maximum hop query was sent given by qsⁱⱼ, the last time a zero hop query was sent given by zqsⁱⱼ, the hop count of the last query sent hqsⁱⱼ, and the last time a query was received qrⁱⱼ. Two maximum hop count queries are always separated at the source of the flood search by a period given by query_send_timeout seconds. A query is forwarded by a receiver only if the difference between the time it is received and qrⁱⱼ is greater than query_receive_timeout, where query_receive_timeout is slightly less than query_send_timeout. The reasoning behind this is perhaps best explained in reference to FIG. 1, wherein time t1 and t3 correspond to times when the querying is started at the source and t3−t1≧query_send_timeout. Because it is possible for the queries to travel different paths, a condition could exist wherein the first flood requires more time to reach the forwarding node than the second flood, such as (t2−t1)≧(t4−t3). If query_receive_timeout were set equal to query_send_timeout in this instance, then the second flood would not be propagated. However, the DST protocol requires that query_receive_timeout is sufficiently large so as to substantially prevent propagation of queries from the same flood search. It will be appreciated that the DST protocol according to the invention uses a novel search approach in which only local clocks are utilized to separate flood searches and this provides an important advantage over the use of sequence numbers, because the protocol becomes more immune to node failures.

3. Routing Information Exchanged in DST

There are two types of control packets utilized in the DST protocol—queries and updates. The control packet headers have the source of the packet (pkt.src), the number of hops (pkt.hops) and an identifier (pkt.type) that can be set to QUERY or UPDATE. Each packet has a list of routing entries in which a destination is specified, a distance to the destination is specified, and a predecessor to the destination is specified.

If the MAC layer allowed for transmission of reliable updates with no retransmission overhead, which is the case for conventional wireless MAC protocols, then only incremental routing updates need to be sent. Herein, however, it is assumed that a MAC protocol is being utilized which is based on collision avoidance. In order to avoid collisions of data packets with other packets in the presence of hidden terminals, such protocols require nodes to defer for fixed periods of time after detecting carrier. Accordingly, the sending of larger control packets does not decrease throughput at the MAC layer, because the overhead (RTS-CTS exchange) for the MAC protocol to acquire the channel does not depend on packet size. Therefore, the description herein assumes that routers transmit their entire routing tables when they send control messages. Control packet size may affect the delay experienced by packets in the MAC layer. However, as the simulations indicate, this does not effect the data packet delays because the number of control packets generated is substantially low. Data packets in the DST protocol are only required to have the source and destination in the header.

4. Creating Routes

When a network is brought up, each node (i) adds a route to itself into its routing table with a distance metric (Dⁱ₁) of zero, the successor equal to itself (i) and the tag (tagⁱ₂) set to Correct. To differentiate a route to itself in relation to all other routes, a node sets the local host address (127.0.0.1) as the predecessor to itself.

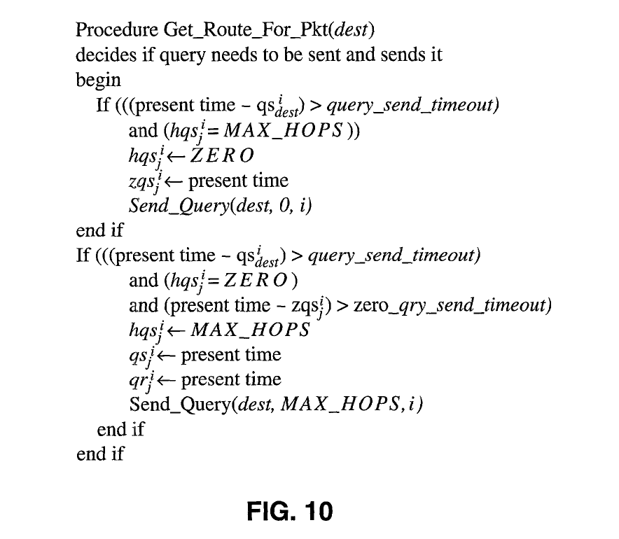

Upon sending a data packet by an upper layer to a forwarding layer, the forwarding layer checks to determine if it has a correct path to the destination. If it does not, then the packet is queued up in the buffer and the router commences a route discovery by calling the procedure Get_Route_For_Packet as shown in FIG. 10.

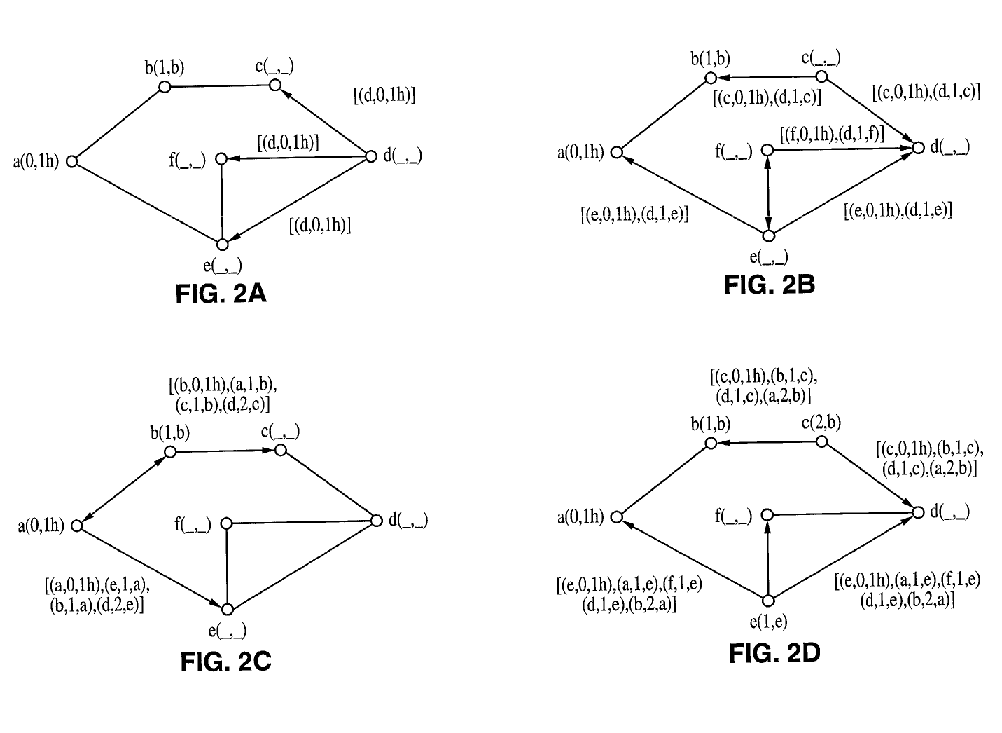

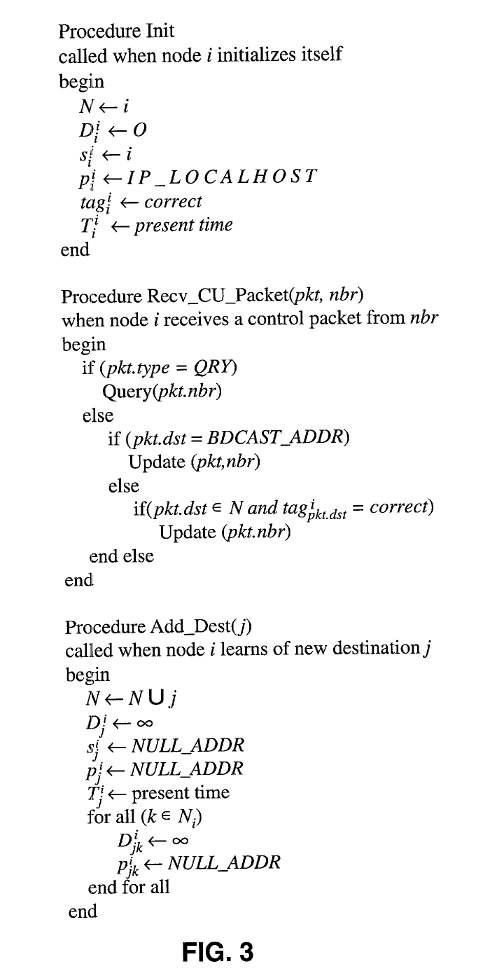

Route discovery cycles are separated by query_receive_timeout seconds. One hop query and one maximum hop query are sent in every cycle. A zero hop query allows the sender to query a neighboring routing table with one broadcast. If the zero hop query times out ((present_time_zqsⁱⱼ)>zero_qry_send_timeout), then an unlimited hop query is sent out. Consider the six-node network in FIG. 2A in which all link costs have a value of unity and where node d broadcasts a query for a destination a, with the pkt.src set to d, pkt.dst set to a, and pkt.hops set to MAX_HOPS (procedure is Send_Query). The parenthesis next to each node in the example depicts the routing table entry (distance, predecessor) for destination a. The symbol lh is used to represent local host address (127.0.0.1). The query packet contains a list of all the routine table entries of sender d. The entries are shown within the square brackets, each entry in a form having destination, distance, predecessor. The entries are ordered by increasing distance, such that a node i receiving a query from an unknown neighbor k, adds the neighbor k to its distance tables on reading the first entry in the query and proceeds to consider all other entries as the distances reported by k.

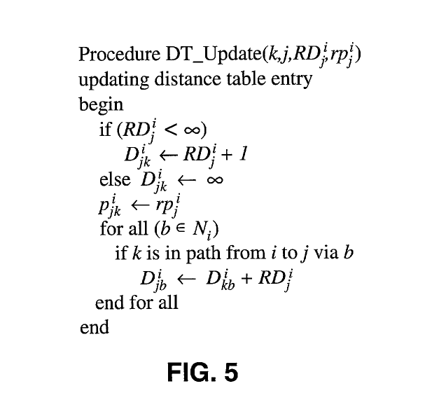

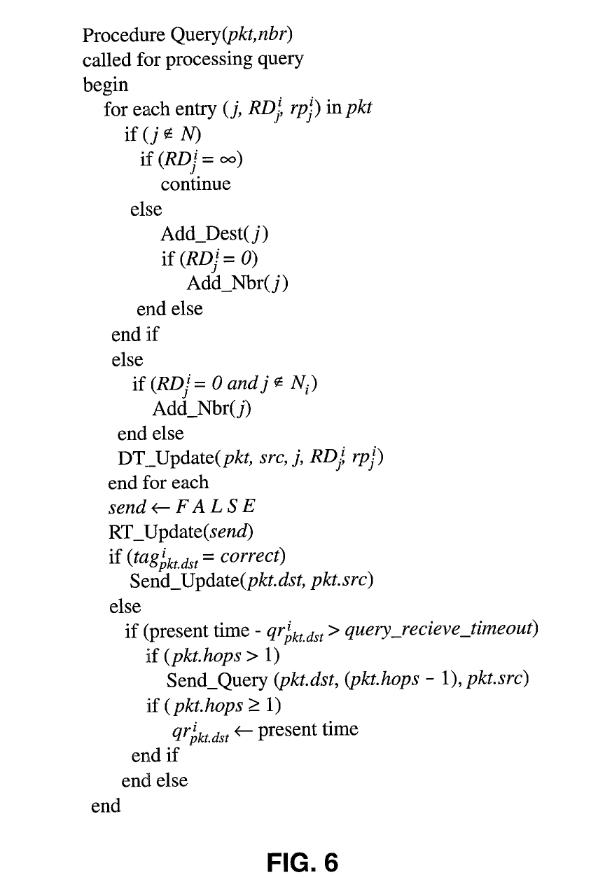

Consider the case of node e, where the function Query of FIG. 6 is called when a query packet arrives from node d. To process the packet, each entry (j,RD^{d}ⱼ,rp^{d}ⱼ) is read and the distance table entry for neighbor d is updated in the function DT_Update in FIG. 5. Since the distance represented by RD^{d}_{d}, is equal to zero, d is marked as a neighbor. The function DT_Update additionally updates the value for j reported by other neighbors whose path contains d. This step helps prevent permanent loops by preemptively removing stale information.

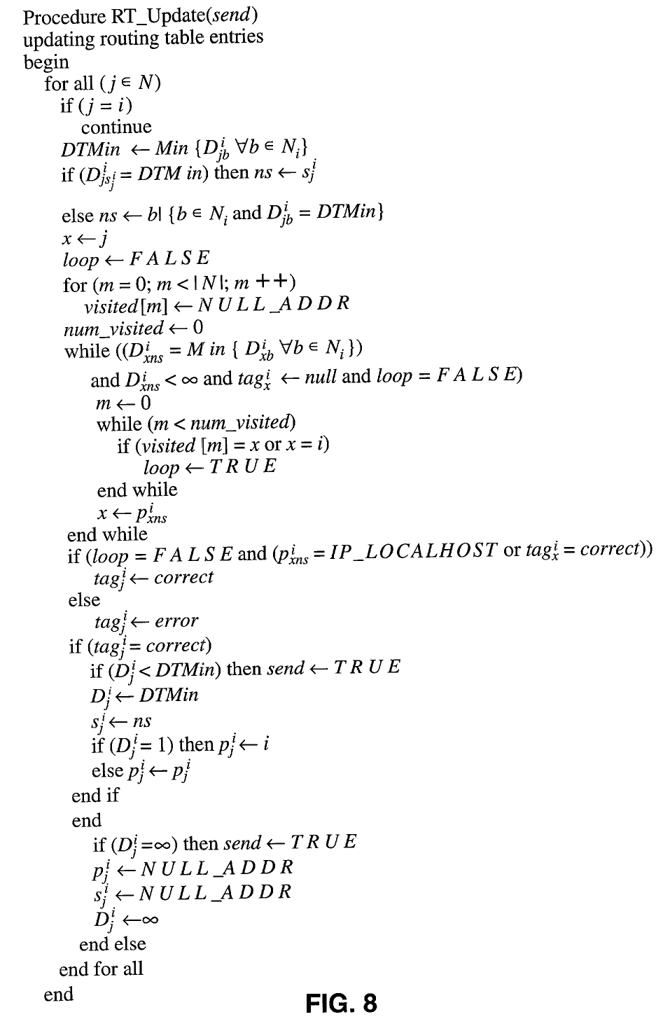

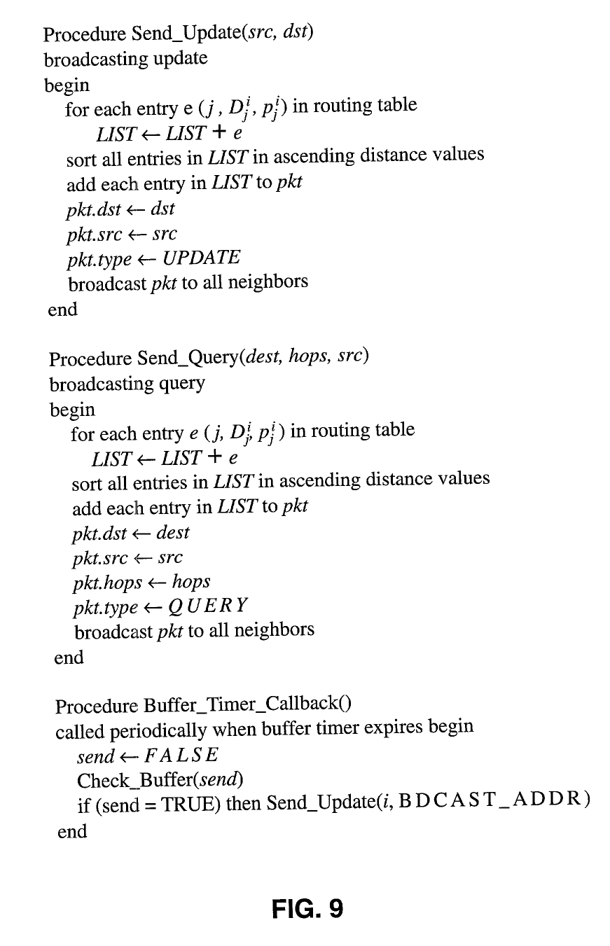

Finally, function RT_Update of FIG. 8 is called to update routing table entries and it iterates through each known destination, picking the neighbor k as a successor to destination j if both of the following conditions are met:

1. k offers the shortest distance to all nodes in the path from j to i.

2. path from j to k contains neither i or any repeated nodes.

If either of the conditions are unsatisfied, then tagⁱⱼ is set to Error, otherwise it is set to Correct and neighbor k is designated the successor and the distance value to j is to Dⁱⱼₖ and the predecessor is set to pⁱⱼₖ.

Subsequent to the processing of the entries and updating the routing table, the node e checks if a route exists to node a. Since no such route exists, a query packet is created with the same header fields as the processed query, besides pkt.hops which is decremented by one if all of the following conditions are met:

1. the node does not have a route to pkt.dst.

2. pkt.hops is greater than one.

3. time elapsed since last query was received is greater than query_receive_timeout .

The routing entries added to the forwarded query reflect the routing table entries of current node e. The packet is then broadcasted to the limited broadcast address. FIG. 2B illustrates nodes e, f, and c broadcasting queries.

FIG. 2C depicts nodes e, f, and a that do not send any additional queries because of the time elapsed since the last query sent is less than query_receive_timeout. In contrast, at nodes a and b, a finite and valid route to a is found and a reply update is sent. A reply update sent by node i has a different structure than a regular update, which has pkt.dst set to the limited broadcast address and pkt.src set to i. The reply update sent by b has field pkt.dst set to the pkt.src=d of the query and the field pkt.src set to the pkt.dst=a of the query. The update preferably contains all the entries in the routing table sorted in order of increasing distance. Preferably all updates are broadcast to the limited broadcast address.

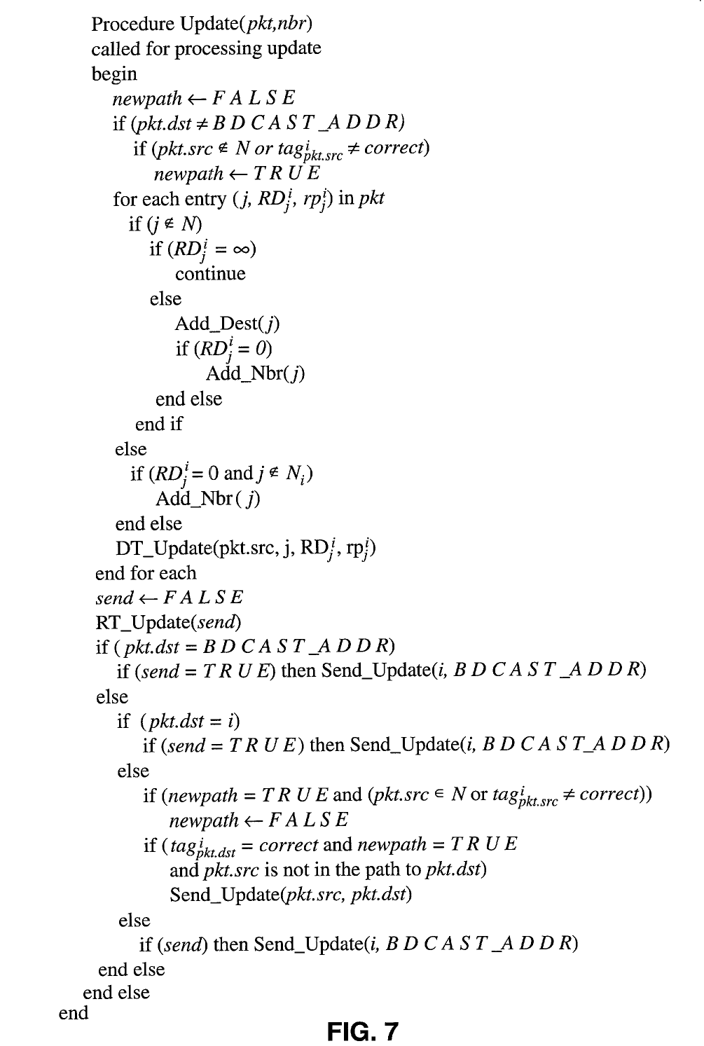

Upon node i receiving an update, it checks the value of pkt.dst, and if it is set to a value other than the limited broadcast address, then the update is being sent in reply update, otherwise it is sent as a regular update. As shown in the procedure Update of FIG. 7, the entries are processed in a manner similar to the entries of the query. A regular update is broadcast in response to a regular update, with pkt.dst set to the limited broadcast address and pkt.src set to i if any of the following conditions are satisfied:

1. distance to a known destination increases;

2. a node loses the last finite route to a destination.

The reply update utilizes a different set of rules for propagation. FIG. 2D illustrates a reply update being rebroadcast by e with the original pkt.dst and pkt.src, because the following two conditions are met:

1. finite path to pkt.dst=d exists;

2. distance to pkt.src=a changes from infinite to finite after the processing of a reply update.

Nodes a and b do not rebroadcast reply updates because the second condition is not satisfied. Node d does not send additional reply updates, however, a regular update will be sent if any of the two conditions for regular updates is satisfied.

Using the above procedure, the DST protocol allows a source to get multiple paths to a required destination. By forwarding a reply update only when the route to the required destination changes from infinite to finite, the number of updates is reduced at the expense of non-optimal routes. The same reasoning is motivation for not sending regular updates when a new destination is found or when a reduction in the distance to a destination occurs. It will be appreciated, however, that an increase in the distance to a destination prompts an update because a loop can occur only when a node picks a neighbor having a distance greater than itself as its successor.

5. Maintaining Routes

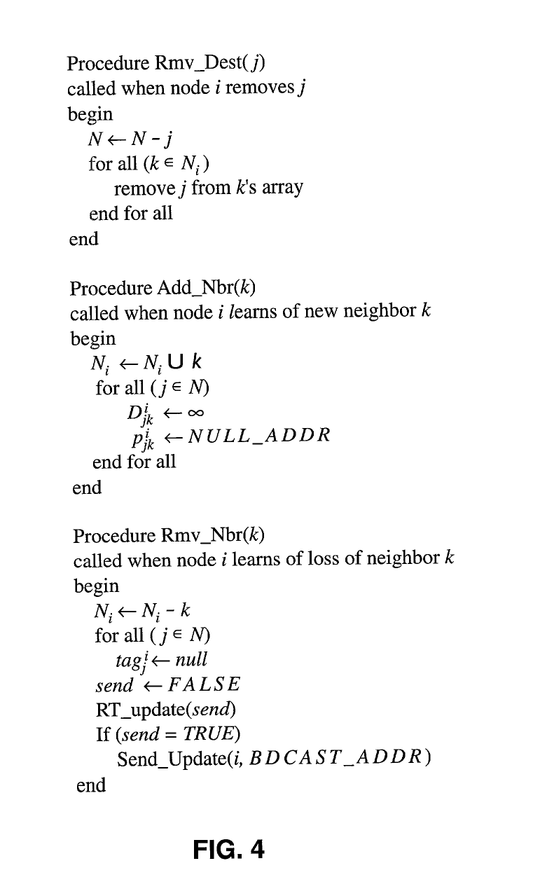

The DST protocol does not poll neighbors constantly to determine link connectivity changes so that the control overhead associated with periodic update messages is reduced, however, this may result in sub-optimal routes and longer convergence times. A link -to a neighbor is discovered only when an update or a query is received from a single neighbor. On finding a new neighbor k, procedure Add_Nbr of FIG. 4 is called. An infinite distance to all destinations through k is assumed, with the exception of node k itself and any destinations reported in the received routing message. A failure of a link is detected when a lower level protocol sends an indication that a data packet can no longer be sent to a neighbor. The procedure Rmv_Nbr of FIG. 4 is called to remove the neighbor from the distance tables. The function RT_Update is then called to compute distances to all destinations.

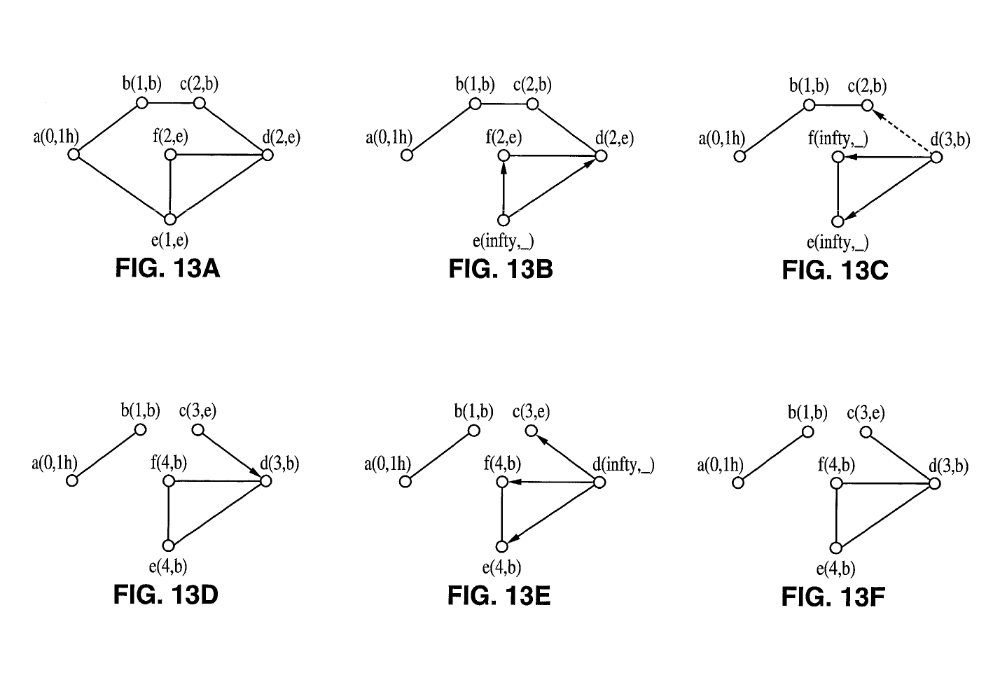

Consider the six-node network in FIG. 13A which is the same as that shown in FIG. 2A after the route discovery cycle which was started by node d for node a has been completed.

Consider the failure of a link between node a and node e, shown in FIG. 13B. Node e does not pick any of its neighbors f and d as successors because tracing the path in RT_Update allows node e to conclude that it lies in the paths of both f and d towards node a. Therefore it will be appreciated that counting to infinity is avoided by the source tracing algorithm. As a result of a distance increase, node e broadcasts an update. Depicted in FIG. 13C is node d which picks node c as its successor and changes its distance to “3” and predecessor to b. Node d sends out a regular update because it increased its distance. Node f also sends out an update, which is not shown for the sake of simplicity.

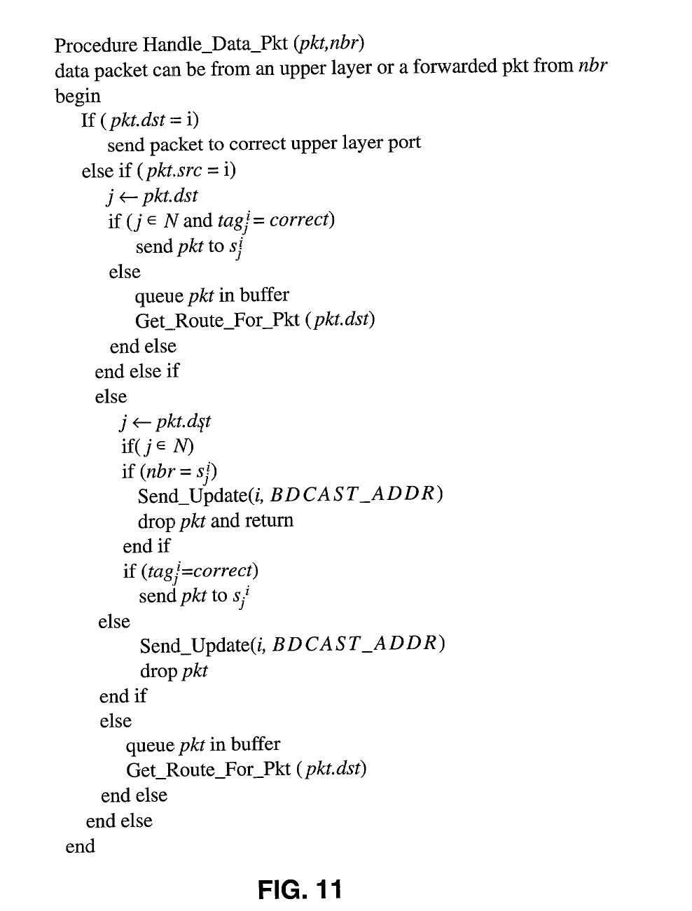

If the assumption is made that due to outside interference or fading that node c does not get the update from node d, and meanwhile, as shown in FIG. 13D, the link between node c and b fails;. Since the distance tables of node c reflect a path through node d with predecessor e, node c increases its distance to “3”, and changes its predecessor to node e, and node c then sends an update. Two different sets of events are now considered. FIG. 13E depicts the update from node b getting through to node d, and node d changing its distance to infinity and send out an update which causes nodes e, f, and c to reset their distance a to infinity. FIG. 13F considers the case where the update from node c to node d is lost. This implies that node d has node c as a successor and node c marks d as its successor. This situation implies a two-hop loop in the tables of c and d. However, in the function Handle_Data_Pkt of FIG. 11 a condition is provided in which a node that receives a data packet from its successor drops the packet and sends out a regular update, which allows node d to eventually receive and update from c and reset its tables. Additionally, it prevents long term data packet looping.

6. Packet Forwarding

Data forwarding in the DST protocol is specified in the procedures Handle_Data_Pkt of FIG. 11 and Check_Buffer FIG. 12. It will be appreciated that the DST protocol allows for separation of the functionality associated with routing and forwarding, insofar as the two layers share the routing table and the forwarding layer is allowed to send the routing layer signals requesting for a destination and requesting for sending of an update.

The data packet header contains only the source and the destination of the data packet. When a data packet originated at a node arrives at its forwarding layer, the packet is buffered if there is no finite route to the destination. The node then starts the route discovery process by calling the function Get_Route_For_Packet of FIG. 10. If a finite and correct route is found, then the packet is forwarded to the successor as specified by the routing table.

If a data packet is not originated at a node, then the data packet is only buffered if there is no entry in the routing table for pkt.dst. In this case, the routing discovery is started by calling the function Get_Route_For_Packet. If there is a correct and finite route, then the packet is forwarded to the successor Sⁱ_{pkt.dst}. If a route exists with infinite distance, then the packet is dropped and a regular update is broadcast to all neighbors.

7. Performance Evaluation

Simulations were performed for two different experimental scenarios to compare the average performance of the DST protocol against the performance of the dynamic source routing (DSR) protocol, as well as our bandwidth efficient source tracing (BEST) protocol described in co-pending U.S. application Ser. No. 09/883,082 filed on Jun. 15, 2001. The simulations provided the ability to independently change the input parameters and check the sensitivity to these parameters as exhibited by the different protocols. Each of the protocols is implemented in CPT, which is a C++ based toolkit which provides a wireless protocol stack and extensive features for accurately simulating the physical aspects of a wireless multi-hop network. The protocol stack in the simulator can be transferred with a minimal amount of effort to a real embedded wireless router. The stack Within the simulation utilizes IP as the network protocol. The routing protocols directly use UDP to transfer packets. The link layer implements the IEEE 802.11 standard and the physical layer is based on a direct sequence spread spectrum radio with a link bandwidth of 1 Mbit/Second.

To run the DST protocol simulation in CPT, a set of DSR code was ported from the ns2 wireless release. A couple of differences exist between the DSR implementation utilized herein and the implementation utilized by others in the industry. Firstly, the “promiscuous listening” mode is not utilized in DSR, however, the “promiscuous learning” mode of source routes from data packets is utilized. This selection follows the specification given in the Internet draft of DSR. The purpose of not allowing promiscuous listening is to reduce the introduction of security problems and to provide compatibility with IP stacks in which the routing protocol is within the application layer and the MAC protocol uses multiple channels to transmit data. The second difference in the present implementation is that since the routing protocol in our stack does not have access to the MAC and link queues, packets can not be rescheduled that have already been scheduled over a link, for either DSR, DST, or BEST. Table 1 and Table 2 exemplify constants for use in simulating DSR and DST protocols respectively.

7.1. Scenarios Used in Comparison

Comparisons were made between the DSR, BEST and DST protocols using two types of scenarios. In both scenarios, the “random waypoint” model was utilized in which each node begins the simulation by remaining stationary for a given pause time in seconds, and then selects a random destination and moves to that destination at a speed of twenty meters-per-second. Upon arriving at the destination, the node pauses again for another pause time, selects another destination to which it then proceeds. The behavior is repeated for the duration of the simulation interval. The speed of twenty meters per second was selected (72 km/hr) as this approximates the speed of a vehicle and has been utilized in earlier wireless protocol benchmarking. Each of the simulation runs were performed over a period of 900 seconds. In both of these scenarios a fifty node ad-hoc network was considered moving over a flat space of dimensions of seven by six miles (11.2×9.7 km) and initially randomly distributed with a density of approximately one node per square mile. Two nodes are presumed to be able to hear one another if the attenuation value of the link between them is such that packets can be exchanged with a probability p where p>0. The attenuation value between two nodes 1 and 2 is calculated using the following equation:

156+40 log(d)−15 log(h1)−15 log(h2)−g1−g2 (1)

where d is the distance in miles, h1 is the height of antenna 1 in feet, h2 is the height of antenna 2 in feet. Both h1 and h2 have been set to twenty feet in the simulation. The value g1 and g2 are the respective gains of antenna 1 and antenna 2, which are both set for gain values of three. Attenuation values are recalculated every time a node moves. Calculated for a distance of one mile the attenuation was one hundred eleven decibels (111 db) and the range of each radio is thereby about four miles, with an attenuation at the four mile point of approximately one hundred thirty five decibels (135 db).

7.2. Metrics Utilized

The protocols were compared using the following set of metrics:

Packet Delivery Ratio—the ratio between the number of packets received by an application and the number of packets sent out by the corresponding peer application at the sender.

Control Packet Overhead—the total number of routing packets sent out during the simulation, with each broadcast packet/unicast packet being counted as a single packet.

Hop Count—the number of hops a data packet has taken from the sender to the receiver.

End to End Delay—the delay a packet suffers from leaving the sender application to arriving at the receiver application. Since dropped packets are not considered, this metric should be taken in context with the metric of packet delivery ratio.

Packet delivery ratio provides an indication of the effect that routing policy has on the throughput that a network can support, and is a reflection of the “correctness” of a given protocol.

Control packet overhead has an effect on the congestion seen in the network and also helps evaluate the efficiency of a protocol. Low control packet overhead is desirable in low-bandwidth environments and in environments in which power consumption is an issue, such as when power is supplied by batteries.

In ad-hoc networks, it is often desirable to reduce the transmitting power to prevent packet collisions, as a result of which the number of hops being taken to reach a given destination increases. However, it will be appreciated that if the power is maintained at a constant level, then the distribution of the number of hops through which data packets travel is a reasonable indication of routing protocol efficiency.

Average end-to-end delay is not an adequate reflection of the delays suffered by data packets, as a few data packets with long delays may skew the results. Therefore, the cumulative distribution function is plotted for the delays to provide a clear understanding of the delays suffered by the bulk of the data packets. It will be appreciated that delay also has an effect on the throughput seen by reliable transport protocols like TCP.

7.3. Performance Results—Scenario 1

Scenario 1 mimics the behavior of an emergency network, or a network configured for military purposes. A total of twenty random data flows is assumed in which each flow occurs peer-to-peer at a constant bit rate (CBR) with a randomly picked destination and the data packet size is kept constant at sixty four (64) bytes. The data flows were started at time that were uniformly distributed between twenty (20) and one hundred twenty (120) seconds and they continue until the end of the simulation at nine hundred (900) seconds. Seven runs of the simulation were performed with each considering a different set of source-destination pairs. The total load on the network was kept constant at eighty data packets per second (80 pkts/s) which results in a bandwidth just over forty kilobits per second (actual value of 40.96 kbps) that reduces data congestion. The rationale for this selection is that increasing the packet rate of each data flow does not test the routing protocol as well as using data flows to varying destinations. The pause time was also varied with pause times being utilized of 0, 30, 60, 120, 300, 600, and 900 seconds.

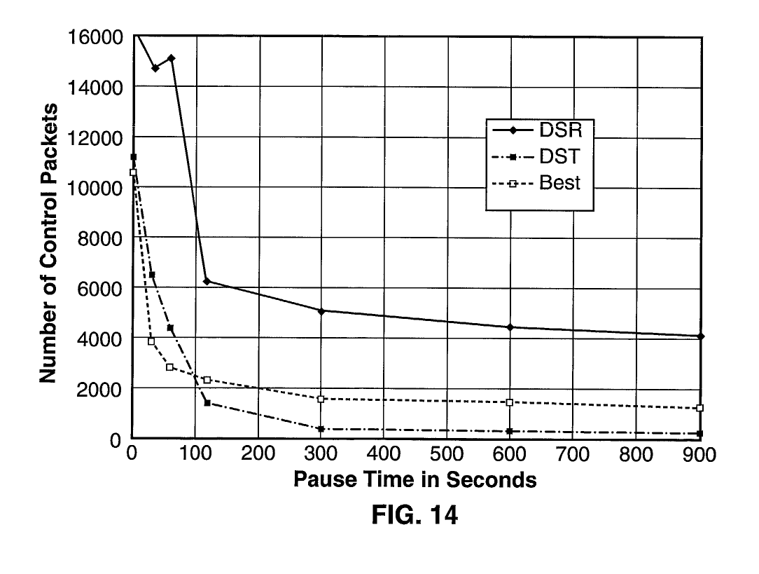

FIG. 14 illustrates the control packet overhead associated with varying the pause times. It will be appreciated that the control packet overhead for all three protocols is reduced as the pause time increases. The BEST and DST protocols were found to provide approximately thirty-four percent better performance than DSR with zero pause times. At low movement rates the DST protocol emerged as the clear favorite with only a third of the control packet overhead that was associated with the BEST protocol and one-tenth of the control packet overhead associated with the DSR protocol. Updating the table within the DST protocol with the entire routing table clearly provides a higher probability of finding paths to destinations for whom no route discovery has been previously performed. The DST protocol can mimic the behavior of table-driven routing protocols in low topology change situations because the majority of the information is available about the entire routing topology with the necessity of few flood searches.

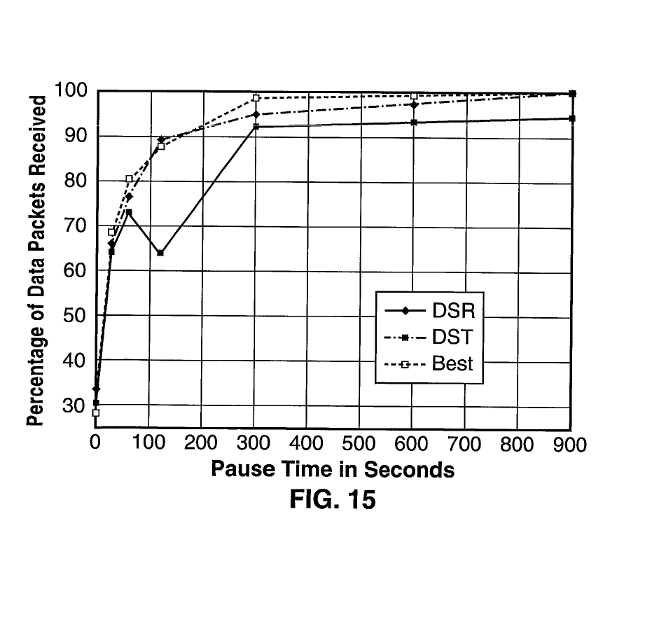

FIG. 15 illustrates that the percentage of data packets delivered for both DST and BEST protocols is similar, and that with lower pause times the DSR protocol provides similar results as obtained with the DST and BEST protocols. It will be appreciated, however, that as pause time decreases the DSR protocol suffers due to data packets being dropped at the link layer which indicates that the routes being provided in the source routes are no longer correct. In considering lower pause times, it will be appreciated that the links are broken more readily. Even though this results in higher control overhead, the routes obtained are relatively new. The load on the network is considered relatively constant, and since the load is divided among a large number of flows the amount of congestion is small and as a result most of the packets get through at higher pause times during which the topology is close to a static condition.

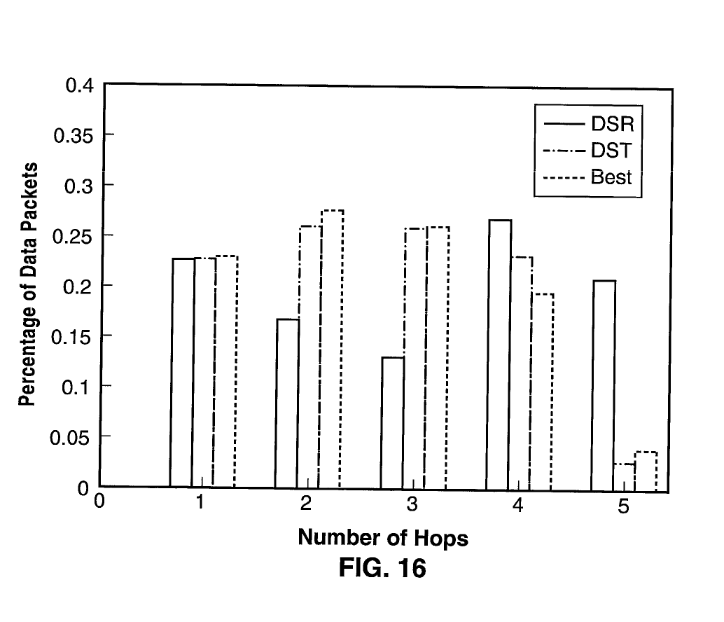

FIG. 16 illustrates the hop count values correlated for data packets during all pause times and plotted as a hop distribution. The three protocols were found to have a similar number of one-hop packets indicating that the zero hop query is very effective in getting routes to neighbors. However, as the number of hops exceeds one it appears that the BEST protocol provides slightly better performance than the other protocols, which would be expected of a table-driven routing protocol that attempts to maintain valid routes at most times. The behavior of DST in FIG. 16 is only slightly behind BEST, while the DSR protocol sends packets through longer routes. The longer routes of DSR are a direct consequence of the fact that after the initial query-reply process, DSR generally uses the route it has cached without trying to improve them.

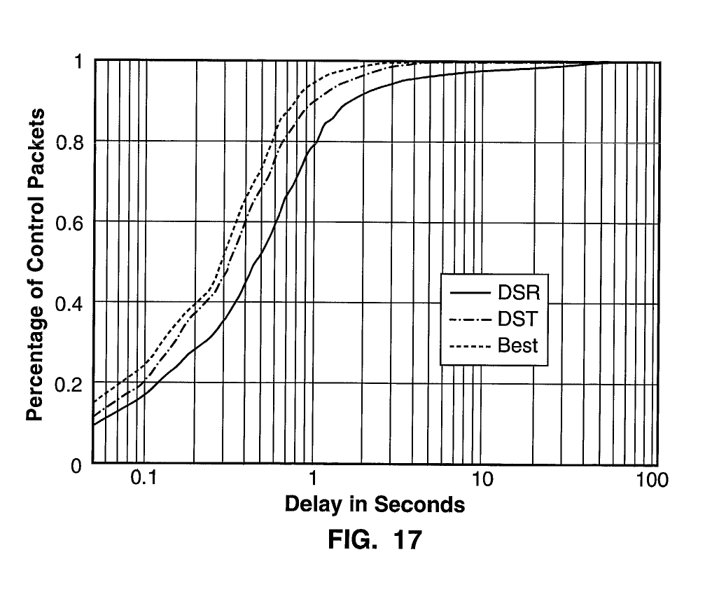

FIG. 17 illustrates cumulative delays for each of the three protocols and is shown using a logarithmic time scale to accommodate the wide variation in results. The BEST protocol provides slightly higher performance than the DST protocol and much higher performance than the DSR protocols. The simulation results show all packets being sent using the BEST protocol within four seconds, and using the DST protocol within eight seconds. The use of the DSR protocol results in packets that are delayed by as much as thirty seconds, because a packet is allowed to remain in a buffer for a maximum of thirty seconds before it is dropped, and the thirty second delay represents packets being “found” just prior to being dropped.

7.4. Performance Results—Scenario 2

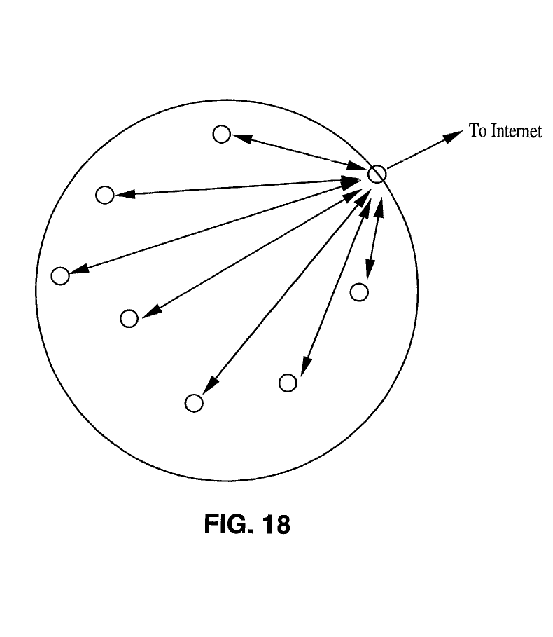

Scenario 2 mimics the applications of ad-hoc networks as wireless extensions to the Internet. In this case, one or two nodes act as points of attachment of the ad-hoc network to the Internet. Accordingly, all Internet traffic travels to and from the attachment points as shown in FIG. 18. The situation is modeled by selecting one node as the point-of-attachment to the Internet for a simulation run of nine hundred (900) seconds and five such runs are performed over which results were collected. During each of the simulation runs, the sender node first establishes a low rate connection (5.85 kbps) with the point-of-attachment. Immediately after the forward connection is established, the backward connection is started from the point-of-attachment to the sender. This connection provides a higher rate connection (40.96 kbps). Each pair of connections lasts for a period, epoch, of three hundred (300) seconds, and seven pairs of connections are started at random times within each epoch. The setup of the simulation closely resembles the number of nodes accessing the Internet through the point-of-attachment. The simulations were run for two pause times including 0 second pausing, indicative of continuous movement, and 900 second pauses which are indicative of no movement.

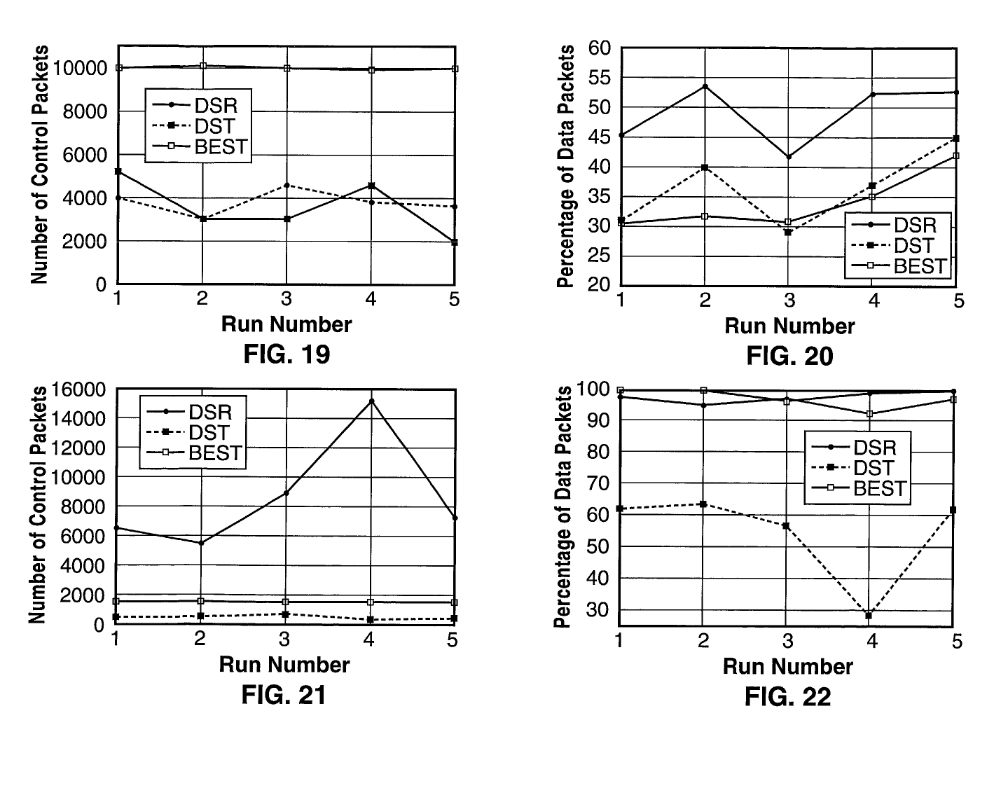

Simulation results are illustrated in FIG. 19 and FIG. 20 for the case of continuous movement. In this simulation the BEST protocol is burdened with a control packet overhead that is approximately double that required by the DST of DSR protocols, as it reacts to the high rate of topology changes. The traffic does not seem to influence the behavior of the BEST protocol because the same information needs to be maintained no matter what point-of-attachment is utilized. DST and DSR require about the same level of control overhead. The DSR protocol performs well in this traffic pattern, sending approximately ten percent more data packets than BEST or DST, because with every flood search towards the point-of-attachment, the point-of-attachment learns the reverse path to the source from the source route accumulated in the queries, while the fast changing topology forces out stale routes from the caches used in the DSR protocol.

FIG. 21 and FIG. 22 illustrate the simulation results for the static case, and it should be appreciated that the topology resembles a static community network, such as households with wireless routers used to reach the internet through an access point. In this scenario the BEST protocol incurs about three times more control overhead than DST, while DSR incurs fourteen times more overhead than that obtained with DST. It will be appreciated that DST performs very well in this scenario because the entire network knows the path to the point-of-attachment with a single flood search. Since there are no changes to the topology there is no necessity of additional flood searches. The BEST protocol provides improved performance for a static network than for a dynamic one, as no topology changes eliminate the need for table driven updates after the initial update which is sent when the network comes up. The DSR protocol illustrated very poor performance in the static network which appears to be primarily driven by the increase in flood searches caused by the old routes. Similarly poor behavior is exhibited by the DSR protocol with a packet loss ratio of about fifty percent, while DST and BEST protocols lost very few packets. The number of packets being lost was found to be very dependent on the congestion caused by an increase in control packets.

It will be appreciated that the present invention may be implemented within wireless routers wherein the need for base station infrastructure is eliminated while looser configurations may be obtained. The DST protocol may be implemented as an application process, such as within a regular TCP/IP stack in which minimal changes to the stack are required. The DST protocol only requires information about links going up and down which are provided by most existing MAC protocols. It will be appreciated that the routing method of the present invention allows mobility and has wide applicability and is especially well suited for use in community networks, emergency networks, and in any area where there is a lack of a viable wired infrastructure.

Accordingly, it will be seen that this invention provides an efficient routing method for use with ad-hoc wireless networks. The operation of an example embodiment according to a set of included procedure has been described. It should be appreciated, however, that one of ordinary skill in the art can make modifications to aspects of the operation and to the procedures without departing from the teachings of the present invention. It will be appreciated that the DST protocol can be tailored to the underlying MAC protocol being utilized, such as reducing the size of the updates if the MAC protocol allows for reliable updates without extra overhead.

Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Constants utilized in DSR Simulation

| time between ROUTE REQUESTS (exponentially backed-off) | 500 (mS) |
|---|---|
| size of source route header carrying n addresses | 4n + 4 |
| | (bytes) |
| timeout for “Ring O” search | 30 (mS) |
| time to hold packets awaiting routes | 30 (Secs) |
| maximum number of pending packets | 50 |

TABLE 2
Constants utilized in DST Simulation

| query send timeout | 5 (Secs) |
|---|---|
| zero query send timeout | 30 (mS) |
| data packet timeout | 30 (Secs) |
| query receive timeout | 4.5 (Secs) |
| MAX_HOPS | 17 |
| maximum number of pending packets | 50 |

What is claimed is:

1. A method of routing data packets between nodes in a wireless network, comprising:
receiving data packet traffic for a destination node;
dynamically tracing a route to said destination node in response to receipt of said traffic if no suitable route is found in the routing table;
loop-checking the complete path prior to entering said dynamically traced route into said routing table; and
transmitting said traffic to said destination node according to said routing table.

2. A method as recited in claim 1, wherein a data packet received for transmission comprises a header with source and destination information.

3. A method as recited in claim 2, wherein said header does not contain a sequence number, or equivalent, associated with the destination node.

4. A method as recited in claim 1:
wherein said dynamic tracing obtains information about the length and second-to-last hop of the shortest path to all known destinations,
whereby counting to infinity problems are avoided.

5. A method as recited in claim 1, wherein entries in said routing table comprise:
an entry for each known destination;
wherein each entry has a destination identifier j;
a successor to said destination, sⁱⱼ;
a second-to-last hop to said destination pⁱⱼ. distance to said destination Dⁱⱼ; and
a route tag tagⁱⱼ.

6. A method as recited in claim 5, wherein the route tag may contain a value selected from the group of route values consisting essentially of correct, null, error, or equivalents, which indicate the status of the route to which said entry is associated.

7. A method as recited in claim 5, wherein a distance table is associated with said routing table and comprises:
a matrix is distance values Dⁱⱼₖ of the route from i to j through k; and
an entry for the second-to-last hop Pⁱⱼₖ on that route.

8. A method as recited in claim 1, wherein routing links to a given neighbor are discovered only in response to traffic being received for destination for which no correct route exists in the routing table.

9. A method as recited in claim 1, wherein said dynamic tracing of routes to the destination is performed by sending Query commands to discover routing information from neighboring nodes.

10. A method as recited in claim 9, wherein a query table is maintained to controls the extent to which a query is forwarded.

11. A method as recited in claim 10, wherein the extent of forwarding is controlled by tracking the number of hops the query has made from the sender in relation to a forwarding limit.

12. A method as recited in claim 11, wherein the forwarding limit comprises a predetermined maximum hop count values, MAX_HOPS, or equivalent.

13. A method as recited in claim 1, wherein links to neighboring nodes are only discovered in response to the receipt of an Update or Query control packet from that neighbor.

14. A method as recited in claim 1, wherein said protocol provides for packet routing without the use of a link-layer protocol for monitoring link connectivity with neighbors.

15. A method for routing data packets in a wireless network at a node i, comprising:
maintaining a routing table of one or more known neighbors along with link cost to said known neighbors;
performing loop checking of complete paths prior to an entry being made into the routing table; and
broadcasting a routing message from said node;
said routing message comprising a vector of entries;
wherein each entry in said vector of entries corresponds to a route in the routing table; and
wherein each said entry in said vector of entries contains a destination identifier j, the distance to the destination Dⁱⱼ, and the second-to-last hop to that destination pⁱⱼ.

16. A method as recited in claim 15:
wherein a first node considers a second as its neighbor if it hears update messages from said second node; and
wherein said first node no longer considers said second node as its neighbor if said first node cannot send data packets to said second node.

17. A method as recited in claim 15, wherein said routing table contains entries for all known destinations with each entry comprising a destination identifier j, the successor to that destination sⁱⱼ, the second-to-last hop to the destination pⁱⱼ, the distance to the destination Dⁱⱼ and a route tag tagⁱⱼ.

18. A method as recited in claim 17:
wherein when the element tagⁱⱼ is set to a value of Correct, it implies a loop-free finite value route;
wherein when element tagⁱⱼ set to Null it implies that the route still remains to be checked; and
wherein when the element tagⁱⱼ is set to Error an infinite metric route, or a route with a loop, is implied.

19. A method as recited in claim 18, further comprising:
maintaining a distance table at said node;
wherein said distance table at router i comprises a matrix of distance values of the route from i to j through k, Dⁱⱼₖ and the second-to-last hop pⁱⱼₖ on that route.

20. A method as recited in claim 19, wherein Dⁱⱼₖ is set to RD^{k}ⱼ+lⁱₖ where RD^{k}ⱼ is the distance reported by k to j in the last routing message and lⁱₖ is the cost of link (i,k).

21. A method as recited in claim 20, wherein said link cost is a function of hop count.

22. A method as recited in claim 20, wherein said link cost is a function of latency.

23. A method as recited in claim 20, wherein said link cost is a function of bandwidth.

24. A method for routing data packets in a wireless network at a node i, comprising:
maintaining a routing table of one or more known neighbors along with link cost to said known neighbors;
routing data packets based on entries in said routing table;
wherein said routing table contains entries for all known destinations;
each said entry in said routing table comprising
a destination identifier j,
the successor to said destination sⁱⱼ,
the second-to-last hop to the destination pⁱⱼ,
distance to the destination Dⁱⱼ, and a route tag tagⁱⱼ.

25. A method as recited in claim 24,
wherein when the element tagⁱⱼ is set to a value of Correct, it implies a loop-free finite value route,
wherein when the element tagⁱⱼ set to Null it implies that the route still remains to be checked, and
wherein when the element tagⁱⱼ is set to Error an infinite metric route, or a route with a loop, is implied.

26. A method as recited in claim 25, further comprising:
maintaining a distance table at said node;
wherein said distance table at router i comprises a matrix of distance values of the route from i to j through k, Dⁱⱼₖ and the second-to-last hop pⁱⱼₖ on that route.

27. A method as recited in claim 26, wherein Dⁱⱼₖ is set to RD^{k}ⱼ+lⁱₖ where RD^{k}ⱼ is the distance reported by k to j in the last routing message and lⁱₖ is the cost of link (i,k).

28. A method as recited in claim 27, wherein said link cost is a function of hop count.

29. A method as recited in claim 27, wherein said link cost is a function of latency.

30. A method as recited in claim 27, wherein said link cost is a function of bandwidth.

31. A method for routing data packets in a wireless network at a node i, comprising:
creating a route for a destination j only when a data packet for j arrives by,
(i) broadcasting a query out to all neighbors;
(ii) forwarding node will forward a query to all its neighbors only if it does not have a route to the destination j and if the following conditions are met:
(a) the number of hops query packet has already been forwarded by <MAX_HOPS,
(b) it has been greater than query_receive_timeout since the last query forwarded for that destination,
whereby only local clocks used for query_recv_timeouts,
(iii) broadcasting back an update instead of forwarding a query if a route to destination j exists and the route value to i decreases from infinite to finite after processing the query,
(iv) utilizing rules in step (iii) to forward an update back to the i node,
(iv) wherein when the update reaches i, i has a route to j.

32. A method for Maintaining a route to a destination, comprising
selecting a neighbor p as the next hop in a route from node i to destination j if,
(i) the path from neighbor p to destination j does not include node i and does not repeat any node, and Dⁱ_{yp}<Dⁱ_{yx},
(ii) for any other neighbor x and for all nodes y that are in the path from destination j to neighbor p, Dⁱ_{yp}>Dⁱ_{yx},
wherein the distance value of the route from node i to node y through neighbor p is the distance value of the route from node i to node y through neighbor x.

33. A method as recited in claim 32, further comprising:
sending updates to a routing table if either of the following conditions are met,
(i) a node loses the last path to a destination, or
(ii) a node suffers a distance increase to a destination.
